(19) United States
(12) Patent Application Publication
(10) Pub. No.: US 2026/0358582 A1
(43) Pub. Date: Nov. 12, 2026

(54) BI-DIRECTIONAL OPTICAL INTERCONNECT

(71) Applicant: NVIDIA CORPORATION, Santa Clara, CA (US)

(72) Inventor: Ashkan Seyedi, Santa Clara, CA (US)

(21) Appl. No.: 19/201,525

(22) Filed: May 7, 2025

(51) Int. Cl. G02B 6/42

(52) U.S. Cl. CPC G02B 6/4246; G02B 6/4291

(57) ABSTRACT

In various embodiments optical interconnects are provided. In an example embodiment, an optical interconnect includes a first transceiver, a second transceiver, and an optical guide. The first transceiver is in optical communication with the second transceiver via the optical guide. The first transceiver is configured to transmit a first optical signal via the optical guide and to receive a second optical signal via the optical guide. The first transceiver comprises a non-destructive optical sensor configured to detect optical intensity of a standing wave generated by interference of the first optical signal and the second optical signal at a detection location.

### BACKGROUND

As artificial intelligence and/or machine learning use increases, the amount of information being communicated between large clusters of computing resources (e.g., graphical processing units (GPUs), central processing units (CPUs), data processing units (DPUs), and/or the like) is also increasing. Links between computing resources and/or chips thereof are based on copper cables (short reach) or optical cables. In the optical cables, the data to be transferred between chips (or switches) is encoded/decoded from electrical to optical signal (and vice versa) and conveyed via an optical fiber. Current systems achieve bi-directional optical communication by operating in a simplex regime, in which transmit and receive signals are sent via different optical fibers or via the same fiber but at different carrier frequencies. The bandwidth capacity achievable by systems that rely on multiple fibers for bi-directional communication is constrained by the size of the systems. While some systems that rely on multiple carrier frequencies for bi-directional communication may achieve greater optical interconnect densities, these systems are more complex and necessitate greater signal processing. Therefore, there is a need for optical interconnects that provide for increased bandwidth capacity.

### GENERAL DESCRIPTION

Optical interconnects are systems that use optical links to transmit data between or within devices, providing for a fast and robust data communication infrastructure. Optical links are communication links that use optical signals (e.g., rather than electrical signals) to transmit data. An optical link may be implemented in various forms. For example, an optical link may be implemented as a physical medium, such a waveguide or fiber. Alternatively, an optical link may be implemented as free-space (e.g., outer space, air, vacuum). Optical interconnects may be implemented at various scales. For example, an optical interconnect may be used for chip-to-chip communication and/or board-to-board communication. Some optical interconnects may be used within integrated circuits (ICs) and/or other high-throughput communication systems.

Some optical interconnect systems achieve bi-directional optical communication by operating in a simplex regime, in which transmit and receive signals are sent via different optical links or via the same optical link but at different carrier frequencies. For example, some optical interconnects employing a single optical fiber use multiple communication channels distinguished by different wavelengths in wavelength division multiplexing (WDM) systems. This configuration is costly in energy, space, and signal processing (e.g., to compensate for any distortions resulting from nonlinearities and performance of various components).

Optical interconnects can be used in a variety of applications, such as switches, processing units (e.g., GPUs, etc.). For example, optical interconnects might optically interconnect NIC-to-switch (network interface controller (NIC) to switch), switch-to-switch, and/or chip-to-chip communication. An optical interconnect may include a substrate and two transceivers supported by the substrate. The optical interconnect may further include an optical link (or interface) through which optical signals may propagate between the two transceivers. For example, an optical interconnect may include an optical guide (e.g., an optical fiber, a waveguide) configured to transmit and receive optical signals between the two transceivers, which are in optical communication with the optical guide.

An optical interconnect typically includes a driver circuit which drives an electro-optical element such as a light emitter (typically with a binary signal), a waveguide (typically an optical fiber), and a receiver. In such a setup the light emitter typically consumes a significant part of the power requirement of the optical interconnect. As an example, a light source may be a Vertical Cavity Surface Emitting Laser (VCSEL) diode to transmit binary data over optical fibers. However, the light source of an optical interconnect may in principle be any suitable light source and the transmitted waveform may be any suitable waveform for transmitting information. An optical interconnect typically includes a transceiver module in each end adapted to transmit optical information along one or two optical fibers. The transmitter of each transceiver typically includes a driver circuit coupled to a light source and a receiver circuit coupled to a photo detector. Typically, optical fibers are used as transmission medium in which case the light source and photo detector will be coupled to fibers. A driver circuit (often located on a driver chip) is a circuit tailored to generate a waveform appropriate to drive a light emitting device in response to an input signal which is typically a binary data stream. The combination of a driver circuit and a light source is referred to as a transmitter. In a typical optical interconnect, a receiver includes a photodetector and receiver circuit (often located on a receiver chip), which is a circuit tailored to receive the output from the photodetector and generate a corresponding binary data stream, from which data encoded on the optical signal can be determined. The photodetector is configured to generate the binary data stream by converting the optical signal into an electrical signal through absorption, which is inherently destructive.

Optical interconnects disclosed herein provide for bi-directional optical communication via a single optical link (e.g., on a single waveguide or fiber) using a single carrier frequency. For example, systems disclosed herein rely on the self-heterodyne effect of optical waves and use a non-destructive optical sensor to detect optical intensity of a standing wave formed from the constructive/destructive interference between a transmit signal and a receive signal propagating through a single optical interconnect (e.g., propagating on a single optical link of the optical interconnect) at substantially the same carrier frequency. Because data carried on the transmit signal is known by the transceiver that generated the transmit signal a priori, data carried on the receive signal may be determined by the transceiver through sensing the magnitude of the standing wave and subtracting the magnitude of the transmit signal from the magnitude of the standing wave. Bidirectional use of an optical interconnect may lead to substantial increases in the bandwidth capacity of the optical interconnect.

One aspect of the present disclosure provides an optical interconnect. The optical interconnect comprises a first transceiver, a second transceiver, and an optical guide. The first transceiver is in optical communication with the second transceiver via the optical guide. For example, the first transceiver is configured to transmit a first optical signal via the optical guide and to receive a second optical signal via the optical guide. The first transceiver comprises a non-destructive optical sensor configured to detect optical intensity of a standing wave generated by interference of the first optical signal and the second optical signal at a detection location.

In at least one example embodiment, the first transceiver comprises a micro-ring cavity evanescently coupled to the optical guide. At least a portion of the first optical signal and at least a portion of the second optical signal may transfer from the optical guide to the micro-ring based at least in part on the micro-ring being evanescently coupled to the optical guide. Generation of the standing wave is based at least in part on the portion of the first optical signal and the portion of the second optical signal counter propagating through the micro-ring.

In at least one example embodiment, the first transceiver is configured to generate a non-modulated optical signal. The micro-ring comprises at least one modulator configured to generate the first optical signal through modulation of the non-modulated optical signal.

In at least one example embodiment, the first optical signal and the second optical signal have substantially the same wavelength. The wavelength is based at least in part on the non-modulated optical signal.

In at least one example embodiment, the detection location is for detection of the optical intensity of the standing wave on the optical guide or the micro-ring.

In at least one example embodiment, the detection location is for detection of the optical intensity of the standing wave on the optical guide. Based at least in part on the detection location, the second transceiver comprises a phase control component configured to synchronize a phase of the second optical signal to a phase of the first optical signal.

In at least one example embodiment, the non-destructive optical sensor is configured to detect the optical intensity of the standing wave at a plurality of detection locations including the detection location. The plurality of detection locations is for detection of the optical intensity of the standing wave on at least one of the optical guide or the micro-ring.

In at least one example embodiment, the non-destructive optical sensor is positioned for detection of the optical intensity of the standing wave within the detection location.

In at least one example embodiment, the non-destructive optical sensor comprises one or more metal pads.

One aspect of the present disclosure provides a method. The method comprises transmitting, by a first transceiver of a bi-directional optical interconnect comprising the first transceiver and a second transceiver, a first optical signal on an optical guide. The first transceiver and the second transceiver are in optical communication with one another via the optical guide. The method also comprises non-destructively detecting an optical power of a standing wave at a detection location, the standing wave generated by interference of the first optical signal and a second optical signal transmitted by the second transceiver on the optical guide. The method further comprises determining data encoded on the second optical signal by subtracting the optical power of the first optical signal from the optical power of the standing wave.

In at least one example embodiment, the first transceiver comprises a micro-ring evanescently coupled to the optical guide. Based at least in part on the micro-ring being evanescently coupled to the optical guide, at least a portion of the first optical signal and at least a portion of the second optical signal transfer from the optical guide to the micro-ring. Generation of the standing wave is based at least in part on the portion of the first optical signal and the portion of the second optical signal counter propagating through the micro-ring.

In at least one example embodiment, the first transceiver is configured to generate a non-modulated optical signal. The micro-ring comprises at least one modulator configured to generate the first optical signal through modulation of the non-modulated optical signal.

In at least one example embodiment, the first optical signal and the second optical signal have substantially the same wavelength. The wavelength is based at least in part on the non-modulated optical signal.

In at least one example embodiment, the detection location is for detection of the optical power of the standing wave on the optical guide or the micro-ring.

In at least one example embodiment, the detection location is on the optical guide. Based at least in part on the detection location, the second transceiver comprises a phase control component configured to synchronize a phase of the second optical signal to a phase of the first optical signal.

In at least one example embodiment, non-destructively detecting the optical power of the standing wave comprises non-destructively detecting the optical power of the standing wave at a plurality of detection locations including the detection location. The plurality of detection locations is for detection of the optical power of the standing wave on at least one of the optical guide or the micro-ring.

In at least one example embodiment, non-destructively detecting the optical power of the standing wave comprises non-destructively detecting the optical power of the standing wave via a non-destructive optical sensor positioned for detection of the optical power of the standing wave within the detection location.

In at least one example embodiment, the non-destructive optical sensor comprises one or more metal pads.

One aspect of the present disclosure provides an optical interconnect structure comprising at least a transceiver and an optical guide. The transceiver is configured for: transmitting a first optical signal on the optical guide, performing non-destructive heterodyne detection of the first optical signal and a second optical signal counter-propagating on the optical guide, and determining data encoded on the second optical signal based at least in part on data encoded on the first optical signal.

In at least one example embodiment, the transceiver comprises a micro-ring evanescently coupled to the optical guide. Based at least in part on the micro-ring being evanescently coupled to the optical guide, at least a portion of the first optical signal and at least a portion of the second optical signal transfer from the optical guide to the micro-ring.

### BRIEF DESCRIPTION OF THE SEVERAL VIEWS OF THE DRAWINGS

Reference will now be made to the accompanying drawings, which are not necessarily drawn to scale, and wherein:

FIG. 1 illustrates a block diagram of an example optical interconnect, in accordance with one embodiment;

FIG. 2 illustrates at least a portion of an example optical network including multiple optical interconnects, in accordance with one embodiments;

FIGS. 3A, 3B, and 3C illustrate some exemplary scenarios of the self-heterodyne effect of optical signals, in accordance with various embodiments;

FIGS. 4A and 4B illustrate exemplary scenarios of encoding a carrier signal with a data signal, in accordance with various embodiments;

FIG. 5 illustrates an exemplary scenario of the self-heterodyne effect of optical communication signals, in accordance with various embodiments;

FIGS. 6A and 6B illustrates exemplary optical links, in accordance with one embodiments;

FIG. 7 illustrates a block diagram of an exemplary optical interconnect in accordance with one embodiment;

FIG. 8A illustrates a top view of at least a portion of a non-invasive capacitive device configured to detect carrier generation within a waveguide structure, in accordance with one embodiment;

FIG. 8B illustrates a cross-section of the waveguide structure, in accordance with one embodiment;

FIG. 8C illustrates a longitudinal profile of the waveguide structure, in accordance with one embodiment;

FIG. 9 illustrates a flowchart of a method for determining data encoded on optical signals counter propagating through an optical guide, in accordance with one embodiment;

FIG. 10 illustrates a block diagram that schematically illustrates a computing system that may include one or more optical interconnects of one embodiment;

FIG. 11 illustrates an exemplary computing environment, in accordance with one embodiment;

FIG. 12 illustrates an example computer system that may include optical interconnects, in accordance with one embodiment;

FIG. 13 illustrates a system, in accordance with one embodiment;

FIG. 14 illustrates a schematic diagram of an example datacenter that may include one or more optical chips, in accordance with various embodiments;

FIG. 15 illustrates a block diagram of example communication devices in communication with one another, in accordance with various embodiments; and

FIG. 16 illustrates exemplary scenarios for use of an optical transceiver, in accordance with some embodiments.

### DETAILED DESCRIPTION

In the following description, various aspects of the present disclosure are described. For purposes of explanation, specific configurations and details are set forth in order to provide a thorough understanding of the present disclosure. However, it will also be apparent to one skilled in the art that the present disclosure may be practiced without the specific details presented herein. Furthermore, well-known features may have been omitted or simplified in order not to obscure the present disclosure. With specific reference to the drawings, it is stressed that the particulars shown are by way of example and for purposes of illustrative discussion of the present disclosure only, and are presented in the cause of providing what is believed to be the most useful and readily understood description of the principles and conceptual aspects of the disclosure. In this regard, no attempt is made to show structural details of the disclosure in more detail than is necessary for a fundamental understanding of the disclosure, the description taken with the drawings making apparent to those skilled in the art how the several forms of the disclosure may be embodied in practice.

Before at least one embodiment of the disclosure is explained in detail, it is to be understood that the disclosure is not limited in its application to the details of construction and the arrangement of the components set forth in the following description or illustrated in the drawings. The disclosure is applicable to other embodiments that may be practiced or carried out in various ways as well as to combinations of the disclosed embodiments. Also, it is to be understood that the phraseology and terminology employed herein are for the purpose of description and should not be regarded as limiting.

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Conventional optical interconnects use multiple optical fibers or multiple carrier frequencies to achieve bi-directional optical communication. These conventional systems are costly in energy, space, and signal processing (e.g., to compensate for any distortions resulting from nonlinearities and performance of single ended electro-optical (EO) components).

Various embodiments provide technical solutions to these technical problems. Optical interconnects disclosed herein provide for bi-directional optical communication using a single carrier frequency and a single waveguide, which may improve energy efficiency and reduce cost. Moreover, such optical interconnects enable denser placement optical interconnect arrays. The term “optical interconnect,” and the like, as used herein, refers to an interconnect structure configured to communicate data via an optical link. An optical link is a communication link that uses optical signals (e.g., rather than electrical signals) to transmit data. That is, an optical link includes an interface on which optical signals carrying data may propagate. The interface of an optical link may be a physical medium (e.g., a waveguide, a fiber) or free-space. In some examples, an optical link may use optical signals to transmit data between two transceivers, which may be in the same device or in two different devices.

In various embodiments, an optical interconnect includes two transceivers in optical communication via an optical guide. The optical interconnect also includes a non-destructive optical sensor configured to detect optical intensity of a standing wave generated by interference of two optical signals propagating through the optical guide. The non-destructive optical sensor does not rely on absorption, which depletes sensed signals. Accordingly, the non-destructive optical sensor, may increase the longevity of the optical signals propagating through the optical guide and reduce heat generation within the optical interconnect, among other benefits. Thus, various embodiments provide technical improvements to the fields of optical interconnects, optical networks, data processing centers, optical communications, and/or the like.

Various embodiments of the present disclosure provide a method for sending and receiving optical signals having a common carrier frequency along a common optical link (e.g., waveguide). The described method relies on the self-heterodyne effect of optical waves and includes the use of a non-destructive optical sensor to detect optical intensity of a standing wave formed from the constructive/destructive interference between a transmit signal and a receive signal propagating through an optical interconnect at a common carrier frequency. For example, the magnitude of the standing wave is a summation of the respective magnitude of the transmit and receive signals and depends on the data carried by the signals. When a portion of the transmit signal and the receive signal at a common location have encoded the same bit value, the magnitude of the standing wave will be at a maximum or a minimum. For example, if the bit value is ‘1’ the standing wave may be at a maximum and if the bit value is ‘0’ the standing wave may be at a minimum. Additionally, when the signals have encoded different bit values, the magnitude of the standing wave will be a non-unique value (e.g., an intermediate value between the maximum and the minimum). The optical interconnect includes two transceivers in optical communication with one another via a waveguide. One of the transceivers is used to generate the transmit signal, while the other transceiver is used to generate the receive signal. Because data carried by the transmit signal is known by the transceiver that generated the transmit signal a priori, the data carried by the receive signal can be determined by the transceiver by sensing the magnitude of the standing wave and subtracting the transmit signal. Bidirectional use of an optical interconnect may lead to substantial increases in the bandwidth capacity of the optical interconnect.

In various embodiments, an optical interconnect includes a micro-ring cavity evanescently coupled to the waveguide. In some such embodiments, the non-destructive optical sensor includes one or more metal pads that can be positioned adjacent to the waveguide and/or the micro-ring cavity. For some embodiments in which metal pad(s) are positioned adjacent to the waveguide, phase control may be used to synchronize the phase of the receive signal to the phase of the transmit signal. Phase control may be omitted for some embodiments in which metal pad(s) are positioned adjacent to the micro-ring cavity. By enabling bi-directional optical communication using a single carrier frequency and a single waveguide, various methods described herein may improve energy efficiency and reduce cost associated with manufacturing and maintaining optical interconnects.

### Example Optical Interconnect

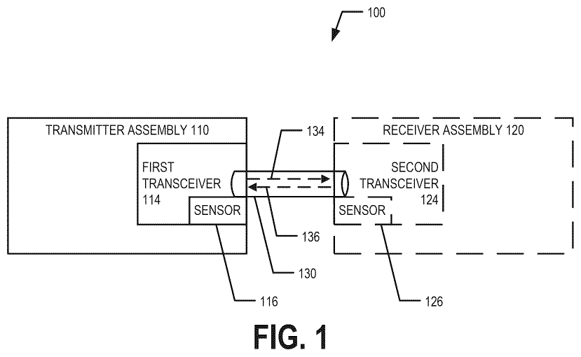

FIG. 1 illustrates a block diagram of an example optical interconnect 100, in accordance with various embodiments. The optical interconnect 100 (e.g., an optical interconnect structure) includes a transmitter assembly 110 having a non-destructive optical sensor 116 and a receiver assembly 120 having a non-destructive optical sensor 126. As discussed herein, the terms “transmitter assembly” and “receiver assembly” are provided for easy of discussion, however both devices include transceivers capable of transmitting and receiving. The transmitter assembly 110 is in optical communication with the receiver assembly 120 via optical guide 130.

The transmitter assembly 110 includes a first transceiver 114. In some examples, the transmitter assembly 110 may include one or more other components configured to provide electrical inputs to drive the first transceiver 114 so as to cause the first transceiver 114 to generate a first modulated optical signal 134 that encodes one or more data streams. In some examples, the optical interconnect 100 may be configured to communicate the one or more data streams from a first processing element to a second processing element. In some examples, the transmitter assembly 110 includes a source of an optical signal. For example, the transmitter assembly 110 may include a continuous wave laser (e.g., a VCSEL). The first modulated optical signal 134 is guided and/or provided to the receiver assembly 120 of the optical interconnect 100 via the optical guide 130 (e.g., a fiber, a waveguide, and/or the like).

The receiver assembly 120 includes a second transceiver 124. In some examples, the receiver assembly 120 includes one or more other components configured to provide electrical inputs to drive the second transceiver 124 so as to cause the second transceiver 124 to generate a second modulated optical signal 136 that encodes one or more data streams. The first modulated optical signal 134 and the second modulated optical signal 136 may have a common carrier frequency. In other words, the carrier frequency of first modulated optical signal 134 is substantially the same as the carrier frequency of the second modulated optical signal 136. In some examples, the carrier of an optical signal may drift. For example, some optical signals may experience a carrier drift within about +/−400 gigahertz (GHz). For discussion in this application, a first optical signal may have substantially the same carrier frequency as a second optical signal if the carrier frequency of the first optical signal is within about 400 GHz of the carrier frequency of the second other optical signal. In other words, a difference between two carrier frequencies that have a common carrier frequency may be about +/−400 GHz.

In some examples, the optical interconnect may be configured to communicate the one or more data streams from the second processing element to the first processing element (or another processing element). In some examples, the receiver assembly 120 includes one or more components configured to control (e.g., modify, adjust) a phase of the second modulated optical signal 136. The second modulated optical signal 136 is guided and/or provided to the transmitter assembly 110 of the optical interconnect 100 via the optical guide 130.

While some examples provided herein illustrate and describe the optical interconnect without a housing or other protective casing, as would be understood by one of ordinary skill in the art in light of the present disclosure, some or all of the optical interconnect of the present disclosure may be supported or enclosed by any housing used in communications systems to protect the components supported therein (e.g., as part of Quad Small Form-factor Pluggable (QSFP) connectors, Small Form Pluggable (SFP) connectors, or the like). Furthermore, the shape of the substrate hosting the transceivers may be dimensioned (e.g., sized and shaped) for use in any communication system regardless of geometric constraints (e.g., L-shaped, squared-shaped, etc.).

In various embodiments, an optical interconnect for receiving an optical fiber may be implemented in a flip-chip configuration. In certain embodiments, the optical interconnect is configured as a flip-chip component such that a longitudinal axis of the first adiabatic transition profile of the optical interconnect and a longitudinal axis of the second adiabatic transition profile of the optical interconnect may be collinear. Said differently, the orientation of the optical interconnect in such an embodiment does not require a mirror or other reflective surface to redirect optical signals between the electro-optical component and the receiving surface. As would be evident to one of ordinary skill in the art in light of the present disclosure, however, the optical interconnect in a flip-chip configuration may also include one or more mirrors (e.g., reflective surfaces) to accommodate optical fibers received at varying angles. In some optical interconnect embodiments, only mirrors may be operationally configured to redirect light given that at some bending radii, light may remain confined to the waveguide. Accordingly, embodiments of a field replaceable modular optical interconnect unit are described that are configured to be received by a main switch system box. The field replaceable modular optical interconnect unit includes a housing including at least a front panel, a rear panel, and side panels extending between the front and rear panels, a printed circuit board assembly supported within the housing, an optical module supported on the printed circuit board assembly and configured to convert between optical signals and corresponding electrical signals for respectively transmitting or receiving optical signals through a fiber optic cable, a board-to-board connector disposed on the rear panel of the housing and configured to enable electrical signals to be transmitted between the printed circuit board assembly and a main switch system box, and an external connector disposed on the front panel of the housing and configured to engage an external optical fiber for transmitting optical signals between the optical module and an external component. The field replaceable modular optical interconnect unit may be configured to be electrically connected to the main switch system box via engagement of the board-to-board connector with a corresponding connector of the main switch system box when the housing is received by the main switch system box.

In some embodiments, the optical module may be a mid-board optical module (MBOM), and/or the field replaceable modular optical interconnect unit may include multiple external connectors. For example, the external connector may be a first external connector, and the field replaceable modular optical interconnect unit may further include a second external connector disposed on the front panel of the housing and configured to enable transmission of electrical signals between the printed circuit board assembly and an external component connected thereto.

### Example Optical Network

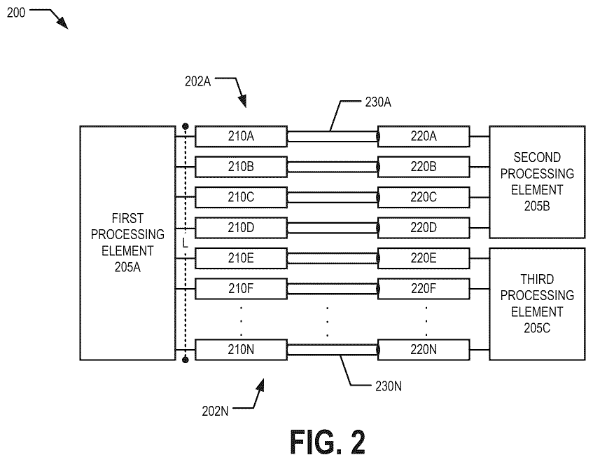

Various embodiments provide an optical network including multiple optical interconnects. For example, FIG. 2 illustrates at least a portion of an example optical network 200 including multiple optical interconnects 202 (e.g., 202A, . . . , 202N), in accordance with various embodiments. For example, a first processing element 205A (e.g., a CPU, GPU, DPU, QPU, PPU chip, and/or the like) is placed into communication with a second processing element 205B (e.g., another CPU, GPU, DPU, QPU, PPU chip, and/or the like), by a first group of the optical interconnects 202 such that one or more data streams generated by the first processing element 205A are communicated to the second processing element 205B via the first group of the optical interconnects 202. A second group of the optical interconnects 202 is configured to place the first processing element 205A into communication with a third processing element 205C (e.g., a different CPU, GPU, DPU, QPU, PPU, chip, and/or the like). In some embodiments, the optical network may also include groups of optical interconnects configured to communicate one or more data streams generated by the second processing element 205B to the first processing element 205A or one or more data streams generated by the third processing element 205C to the first processing element 205A. In an example embodiment, additional groups of the optical interconnects 202 may be provided for communication between the second processing element 205B and the third processing element 205C. In one example, the processors may include central processing units (CPUs), graphics processing units (GPUs), data processing units (DPUs), quantum processing units (QPUs), a plurality of parallel processing units (PPUs), and application-specific integrated circuits (ASICs). QPUs configured to perform one or more operations associated with a quantum algorithm In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

In various embodiments, the optical network 200 may include multiple processing elements 205. For example, the illustrated at least a portion of the optical network 200 includes the first processing element 205A, the second processing element 205B, and a third processing element 205C. The optical network further includes optical interconnects 202 that are arranged and/or configured to place respective pairs of processing elements into communication with one another.

Each optical interconnect 202 includes a transmitter assembly 210 (e.g., 210A, . . . , 210N) that is in electrical communication with a respective processing element 205. Each of the transmitter assemblies 210 may be similar to transmitter assembly 110. For example, a transmitter assembly 210 may include a first transceiver. The transmitter assembly 210 may further include a source of an optical signal, traces, leads, wires, bias Ts, bonding pads, waveguide and/or optical fiber coupling component, and/or the like configured for placing the components of the transmitter assembly 210 into electrical and/or optical communication with one another and/or other components of the optical network 200.

Each optical interconnect 202 further includes a receiver assembly 220 (e.g., 220A, . . . , 220N) that is in electrical communication with a respective processing element 205. Each of the receiver assemblies 220 may be similar to receiver assembly 120. For example, a receiver assembly 220 may include a second transceiver in optical communication with the first transceiver. In some examples, a receiver assembly 220 may include a source of an optical signal. In some other examples, an optical signal (e.g., a carrier wave for an optical signal) may be provided to the receiver assembly 220 by a transmitter assembly 210. The receiver assembly 220 may further include traces, leads, wires, bias Ts, bonding pads, waveguide and/or optical fiber coupling component, and/or the like configured for placing the components of the receiver assembly 220 into electrical and/or optical communication with one another and/or other components of the optical network 200. In some examples, the receiver assembly 220 may include one or more components configured to control a phase of a modulated optical signal.

Each optical interconnect 202 further includes an optical guide 230 (e.g., 230A, . . . , 230N) that is in optical communication with the transmitter assembly 210 and the receiver assembly 220 of the optical interconnect 202. That is, the first transceiver of the transmitter assembly 210 may be in optical communication with the second transceiver of the receiver assembly 220 via the optical guide 230. In some examples, the transmitter assembly 210 may be configured to transmit a first optical signal via the optical guide 230 to the receiver assembly 220, and to receive a second optical signal from the receiver assembly 220 via the optical guide 230.

A transmitter assembly 210 of an optical interconnect 202 is in communication with a respective processing element 205 and the receiver assembly 220 of the optical interconnect 202 is in communication with a different respective processing element 205 such that data streams may be communicated from the respective processing element 205 in communication with the transmitter assembly 210 to the other respective processing element 205 in communication with the receiver assembly 220. For example, the transmitter assembly 210N of the Nth optical interconnect 202N is in communication with the first processing element 205A and the receiver assembly 220N of the Nth optical interconnect 202N is in communication with the third processing element 205C such that one or more data streams may be communicated from the first processing element 205A to the third processing element 205C via the Nth optical interconnect 202N.

In various embodiments, the optical interconnects are configured to be placed into communication with respective processing elements in dense arrays. For example, the transmitter assemblies 210A-210N are arranged in a one-dimensional array of length L. In various embodiments, the number of transmitter assemblies N in the array and the length L are configured such that the density of transmitter assemblies is eight or more transmitter assemblies per linear foot. In various embodiments, processing elements 205 of the optical network are configured such that the density of optical interconnects is at least eight optical interconnects per square foot at the processing element.

In various embodiments, the optical interconnects 202 provide for bi-directional optical communication using a single carrier frequency and a single optical link (e.g., a single waveguide or fiber). For example, the optical interconnects 202 may rely on the self-heterodyne effect of optical waves and uses a non-destructive optical sensor to detect optical intensity of a standing wave formed from the constructive/destructive interference between a transmit signal and a receive signal propagating through a common optical interconnect at a common carrier frequency (e.g., substantially the same carrier frequency). Bidirectional use of the optical interconnects 202 may lead to substantial increases in the bandwidth capacity of the optical network 200, which may enable the optical network 200 to provide communication between processing elements in a spatially-conscious manner while requiring less electrical power.

### Self-Heterodyne Effect of Optical Signals

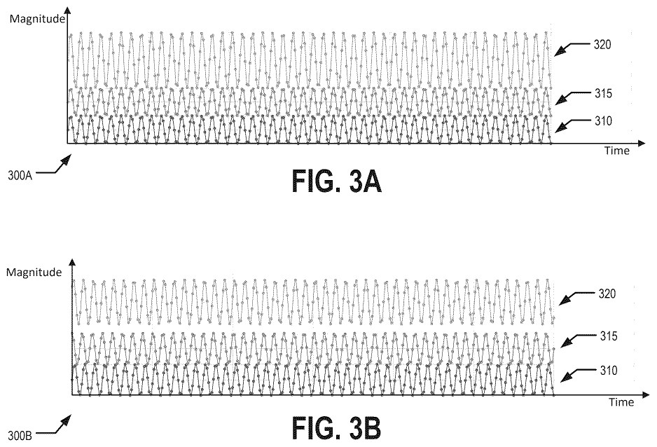

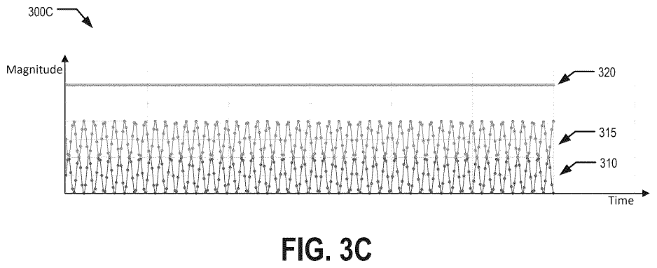

FIGS. 3A, 3B, and 3C illustrate some exemplary scenarios 300 (e.g., 300A, 300B, 300C) of the self-heterodyne effect of optical signals, in accordance with various embodiments. The self-heterodyne effect of optical signals is the constructive or destructive interference of the optical signals (e.g., light), given their wave nature. In other words, because optical signals behave as sinusoidal waves, two optical signals with substantially the same carrier frequency add constructively or destructively. For example, two sinusoidal waves (optical signals) that are of the same wavelength and phase add constructively to each other.

As illustrated in scenario 300A of FIG. 3A, a first optical signal 310 and a second optical signal 315 have the same wavelength, the same (relative) magnitude, and the same phase. It will be appreciated by those skilled in the art that the respective magnitude of first optical signal 310 and the second optical signal 315 are offset with respect to one another for illustration purposes (e.g., so that the respective magnitude of the first optical signal 310 and the second optical signal 315 are non-overlapping). The magnitude may be representative of optical intensity (or optical power). The resulting sum of the first optical signal 310 and the second optical signal 315 is illustrated as a third optical signal 320. In other words, the third optical signal 320 represents the interference between the first optical signal 310 and the second optical signal 315. It will be appreciated by those skilled in the art that the magnitude of the third optical signal 320 is offset relative to the first optical signal 310 and the second optical signal 315 for illustration purposes (e.g., so that the respective magnitude of the first optical signal 310, the second optical signal 315, and the third optical signal are non-overlapping).

In the example of FIG. 3A, the first optical signal 310 and the second optical signal 315 interfere constructively (e.g., purely constructively). Thus, in the example of FIG. 3A, the third optical signal 320 has the same wavelength (and phase) as the first optical signal 310 and the second optical signal 315, and has approximately double the magnitude of the first optical signal 310 and the second optical signal 315. That is, due to the first optical signal 310 and the second optical signal 315 having the same phase (e.g., being in phase with one another), the first optical signal 310 and the second optical signal 315 constructively interfere throughout the length (in time) of the first optical signal 310 and the second optical signal 315. Thus, the magnitude of the first optical signal 310 and the second optical signal 315 add constructively throughout the length of the first optical signal 310 and the second optical signal 315. Accordingly, because the first optical signal 310 and the second optical signal 315 have the same magnitude, the (relative) magnitude of the third optical signal 320 throughout the length (in time) of third optical signal 320 is approximately double the magnitude of each of the first optical signal 310 and the second optical signal 315.

In the example of FIG. 3B, the first optical signal 310 and the second optical signal 315 have the same wavelength and magnitude but are phase-shifted by about 90 degrees. That is, as illustrated in scenario 300B of FIG. 3B, a 90 degree phase difference exists between the first optical signal 310 and the second optical signal 315 (denoted by an offset in the valleys and peaks of the first optical signal 310 and the second optical signal 315). Due to the 90 degree phase difference between the first optical signal 310 and the second optical signal 315, the first optical signal 310 and the second optical signal 315 do not interfere constructively throughout the length (in time) of the first optical signal 310 and the second optical signal 315. In other words, due to the 90 degree phase difference between the first optical signal 310 and the second optical signal 315, neither purely constructive interference nor purely destructive interference occurs. As such, the magnitude of the first optical signal 310 and the second optical signal 315 do not add constructive (e.g., purely constructively). Thus, the magnitude of third optical signal 320 in the example of FIG. 3B is less than the magnitude of the third optical signal 320 in the example of FIG. 3A. In other words, the 90 degree phase difference between the first optical signal 310 and the second optical signal 315 caused the magnitude of the third optical signal 320 to decrease (denoting that the signals in FIG. 3B are not adding as constructively through the entire signal).

In the example of FIG. 3C, the first optical signal 310 and the second optical signal 315 have the same wavelength and magnitude but are phase-shifted by 180 degrees. That is, as illustrated in scenario 300C of FIG. 3C, a 180 degree phase difference exists between the first optical signal 310 and the second optical signal 315 (e.g., denoted by the peaks of the first optical signal 310 being aligned with the valleys of the second optical signal 315). Due to the 180 degree phase difference between the first optical signal 310 and the second optical signal 315, the first optical signal 310 and the second optical signal 315 interfere destructively (e.g., purely destructively) throughout the length (in time) of the first optical signal 310 and the second optical signal 315. As such, the magnitude of the first optical signal 310 and the second optical signal 315 add destructive (e.g., purely destructively, subtract). Thus, the relatively magnitude of third optical signal 320 in the example of FIG. 3B is 0. In other words, due to a full 180 degree phase difference between the first optical signal 310 and the second optical signal 315, the first optical signal 310 and the second optical signal 315 interfere perfectly to cancel each other out. The described method relies on the self-heterodyne effect of optical waves and includes the use of a non-destructive optical sensor to detect optical intensity of a standing wave formed from the constructive/destructive interference between a transmit signal and a receive signal propagating through an optical interconnect at substantially the same frequency.

### Encoding a Carrier Signal With a Data Signal

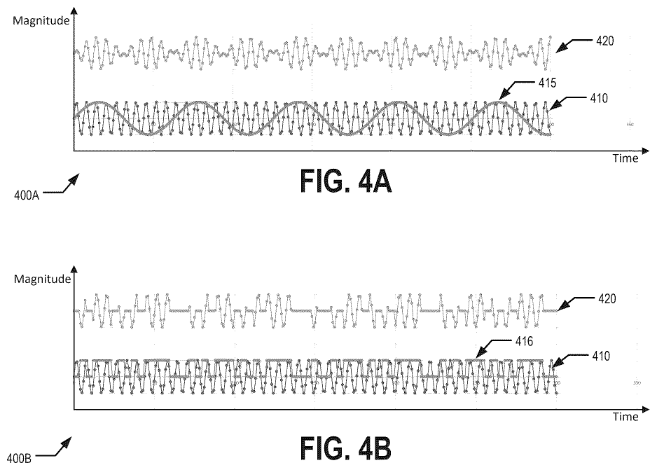

FIGS. 4A-4B illustrate exemplary scenarios 400 (e.g., 400A, 400B) of encoding a carrier signal with a data signal, in accordance with various embodiments. The term “optical communication signal,” and the like, as used herein, refers to an optical signal used to communicate information (e.g., data). In other words, an optical communication signal is an optical signal on which data is encoded. Thus, as illustrated in the examples of FIGS. 4A and 4B, an optical communication signal 420 may be the product of a carrier signal and a data signal.

In the example FIG. 4A, the optical communication signal 420 is representative of the product of the carrier signal 410 (e.g., with a wavelength of 0.1) and a sinusoidal data signal 415 (e.g., a single-frequency sine wave with a wavelength of 1). Accordingly, the optical communication signal 420 shows the slower envelope of the sinusoidal data signal 415 embedded on the faster carrier signal 410. In some examples, the frequency of a carrier signal may be about three (or more) orders of magnitude higher than the frequency of the data signal. For example, the carrier signal may be in the range of about 200 terahertz (THz) and the data signal may range from about 100 GHz to about 200 GHz. A three orders of magnitude separation in the frequencies of the carrier signal and the data signal may improve filtering and de-embedding of the carrier signal and data signal.

In the example of FIG. 4B, the optical communication signal 420 is representative of the product of a binary data signal 416 (e.g., an arbitrary binary data signal) and the carrier signal 410. In other words, the optical communication signal 420 is representative of the binary data signal 416 encoded on top of the carrier signal 410. That is, the optical communication signal 420 results from binary data being encoded on an optical signal (e.g., the carrier signal 410). As illustrated in the example of FIG. 4B, the binary data signal 416 effectively samples the carrier signal 410 when the value of the binary data signal 416 is ‘1’ (e.g., when a ONE signal is encoded). The described method uses a non-destructive optical sensor to detect optical intensity of a standing wave formed from the constructive/destructive interference between a transmit signal and a receive signal propagating through an optical interconnect, in which, for the transmit signal and the receive signal, a respective binary data signal is embedded on a common carrier signal (e.g., carrier signals that are substantially the same).

### Self-Heterodyne Effect of Data Signals

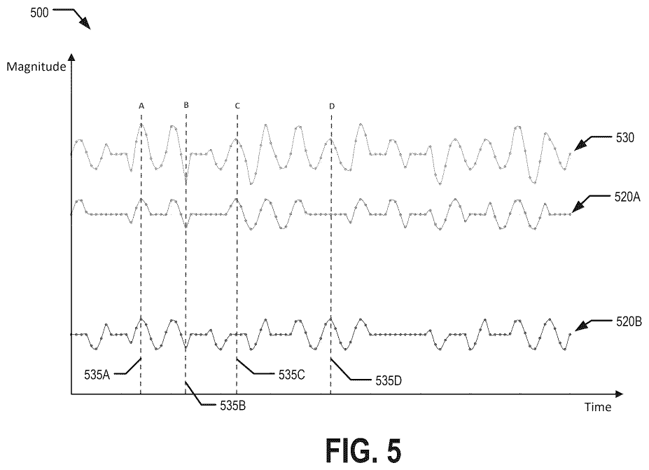

FIG. 5 illustrates an exemplary scenario 500 of the self-heterodyne effect of optical communication signals, in accordance with various embodiments. In the example of FIG. 5, a self-heterodyned signal 530 represents the addition of an optical communication signal 520A and an optical communication signal 520B (e.g., two arbitrary data signals with substantially the same carrier frequency, as may be the case in a bi-directional system).

As illustrated in the example of FIG. 5, when the optical communication signal 520A and the optical communication signal 520B have the same binary value encoded (e.g., ‘1’ or a ‘0’) encoded the magnitude of the self-heterodyned signal 530 will be a unique value (e.g., a maximum or a minimum). For example, at time instance 535A, both the optical communication signal 520A and the optical communication signal 520B have ‘1’ encoded. Accordingly, at the time instance 535A, the magnitude of the self-heterodyned signal 530 is at a maximum (e.g., because the sum of the optical communication signal 520A and the optical communication signal 520B is a maximum). Additionally, at time instance 535B, both the optical communication signal 520A and the optical communication signal 520B have ‘0’ encoded. Accordingly, at the time instance 535B, the magnitude of the self-heterodyned signal 530 is at a minimum (e.g., because the sum of the optical communication signal 520A and the optical communication signal 520B is a minimum).

Additionally, as illustrated in the example of FIG. 5, when the optical communication signal 520A and the optical communication signal 520B have different binary values encoded, the magnitude of the self-heterodyned signal 530 will be a non-unique value (e.g., an intermediate value between the maximum and the minimum). For example, at time instance 535C and time instance 535D, one of the optical communication signal 520A or the optical communication signal 520B has a ‘1’ encoded and the other has a ‘0’ encoded. Accordingly, at the time instance 535C and the time instance 535D, the magnitude of the self-heterodyned signal 530 is an intermediate value between the maximum and the minimum (e.g., because the sum of the optical communication signal 520A and the optical communication signal 520B is an intermediate value between the maximum and the minimum).

As illustrated in the example of FIG. 5, the magnitude of the optical communication signals 520 change as a function of time, which implies a spatial dependence on the optical communication signals 520. The spatial dependence of the optical communication signals 520 (and thus the self-heterodyned signal 530) may be leveraged to successfully decode data embedded on the optical communication signals 520. For example, the optical communication signal 520A may be a transmit signal and the optical communication signal 520B may be a receive signal. That is, a first data stream (Data 1) encoded on the optical communication signal 520A may be from a first entity and a second data stream (Data 2) encoded on the optical communication signal 520B may be received at the first entity from a second entity. Because the first entity sent the first data stream (and is therefore aware of the first data stream), the optical communication signal 520A is a deterministic signal. Accordingly, the optical communication signal 520A may be compared to the self-heterodyned signal 530 (e.g., via a calibrated truth table) to the de-embed the optical communication signal 520A and the optical communication signal 520B from the self-heterodyned signal 530. That is, the optical communication signal 520A may be compared to the self-heterodyned signal 530 to obtain the second data stream (encoded on the optical communication signal 520B) from the second entity.

### Example Optical Links

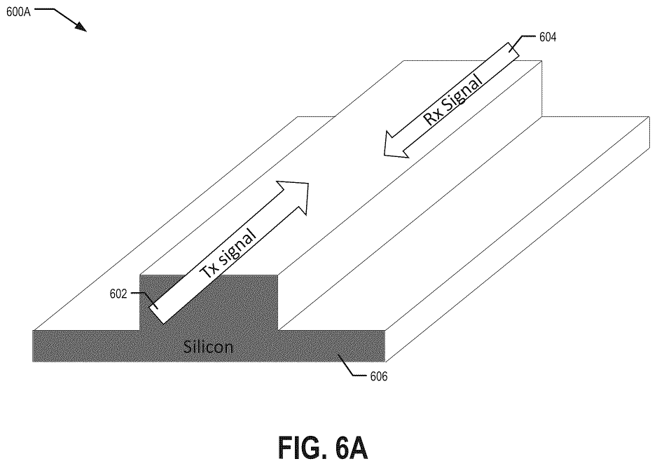

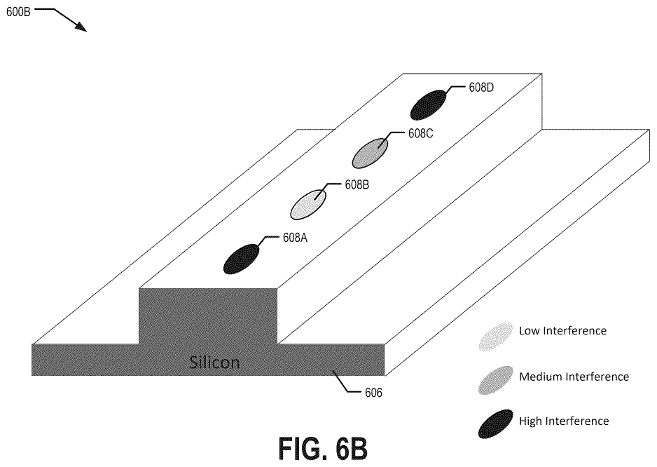

Various embodiments of the present disclosure provide an optical interconnect configured for sending and receiving optical signals having a common carrier frequency along a common optical link. The optical link may be a physical medium (e.g., a waveguide, a fiber) or free-space. FIGS. 6A and 6B illustrate exemplary optical links 600 (e.g., 600A, 600B), in accordance with various embodiments. In the example of FIGS. 6A and 6B, the optical links 600 are waveguides. Although the examples of FIGS. 6A and 6B illustrate the optical links 600 as waveguides, it is to be understood that the optical interconnect, method, and device provided herein are applicable to other types of optical links, such as fibers. The examples illustrated in FIGS. 6A and 6B are merely examples and should not be construed to narrow the scope of the disclosure or appended claims.

FIGS. 6A and 6B illustrate optical links 600 (e.g., waveguides) having a core 606, which is used to guide optical signals (e.g., light) propagating on the optical links 600. As illustrated in the example of FIGS. 6A and 6B, the core 606 may be made of silicon (Si). Although the examples of FIGS. 6A and 6B illustrate the core 606 as a silicon core, it is to be understood that the optical interconnect, method, and device provided herein are applicable to other types of core materials, such as a polymer, lithium niobate (LiNbO₃), or chalcogenide glass. In some examples, the core 606 may be doped (e.g., with various elements, such as germanium or phosphorous) to adjust the refractive index of the core 606. Additionally, or alternatively, in some examples, the core 606 may be a hybrid waveguide combining multiple types of materials, such as silicon and a polymer. The examples illustrated in FIGS. 6A and 6B are merely examples and should not be construed to narrow the scope of the disclosure or appended claims. In some examples, the core 606 may be surrounded by a cladding. Additionally, or alternatively, as illustrated in the example of FIGS. 6A and 6B, the core 606 may be surrounded by air. That is, the optical links 600 may be examples of ridge waveguide silicon surrounded by air.

As illustrated in the example of FIG. 6A, the optical links 600 support bi-directional signaling. That is, the optical links 600 support two counter-propagating signals, including a transmit (Tx) signal 602 and a receive (Rx) signal 604. An interconnect including the optical link 600A (or the optical link 600B) may tune a phase delay of the Rx signal 604 and/or the Tx signal 602 so that the Tx signal 602 and the Rx signal 604 are in-phase at one or more detection locations (e.g., detection points). In some examples, the optical interconnect may tune the phase delay using a calibration technique or one or more other types of techniques suitable for synchronizing the phase of two counter-propagating signals.

In some examples, the optical interconnect may tune the phase delay of the Rx signal 604 and/or the Tx signal 602 so that a standing wave forms at one or more detection locations. For example, a standing wave pattern may form in a waveguide due to interference between two counter-propagating signals of the same or substantially similar frequencies (e.g., the Tx signal 602 and the Rx signal 604). The standing wave pattern includes alternating high and low intensity regions (e.g., locations) and non-linear effects occur at the locations of high intensity (or power) causing heating and current. The high and low intensity regions may be referred to herein as crests and valleys, respectively. The locations of high intensity generate free carriers (e.g., electron-hole pairs) through absorptive processes, such as two-photon absorption. The accumulation of free carriers at the locations of high intensity contribute to resistive heating and induce a photocurrent. The photocurrent may be detected, for example, using a non-destructive probe configured to measure changes in electrical conductivity. In other words, a non-destructive sensor may be used to monitor variations in the conductance of the optical link 600A that are induced by a carrier generation effect occurring through absorptive processes (e.g., two-photon absorption) at locations of high optical intensity. In some examples, an amp meter (or another type of sensor configured to measure current) may be used to identify the locations of high optical intensity. As illustrated in the example of FIG. 5, the magnitude of a signal (e.g., a self-heterodyned signal) formed from the interference of two optical communication signals varies overtime according to the two optical communication signals from which the signal is formed. As such, the magnitude of a time-varying signal formed from the interference between the Tx signal 602 and the Rx signal 604 may be sensed at the locations of high intensity. The Tx signal 602 (known by the transmitter) may be compared to the sensed signal to determine the Rx signal 604 (e.g., to determine data sent via the Rx signal 604).

In some examples, a contactless integrated photonic probe (CLIPP) detector may be used to non-destructively sense a standing wave formed from the interference between the Tx signal 602 and the Rx signal 604. For example, a CLIPP detector may capacitively couple to the optical link 600A (or the optical link 600B) to measure changes in the electrical conductivity of the optical link 600A included by photogenerated carriers. As the optical intensity of the standing wave changes, the carrier density (and thus conductance) also changes. The CLIPP detector may sense changes in the conductance with optical intensity that are induced by the photogenerated carriers, thereby enabling non-destructive, real-time monitoring of optical intensity.

As illustrated in the example of FIG. 6B, a signal (e.g., a summation signal, a self-heterodyned signal) formed from the interference of two optical communication signals varies along the length of the optical link 600B. For example, since a self-heterodyned signal resulting from the two interfering optical signals propagating on an optical link has a time dependence (as illustrated in the example of FIG. 5), the signal also has a spatial dependence along the length of the optical link. In the example of FIG. 6B, at a detection location 608A and a detection location 608D, interference (and thus the optical intensity) in the summation signal is high (e.g., at a maximum) and, as such, the optical intensity at the detection location 608A and the detection location 608D is also high. The interference at the detection location 608A and the detection location 608D may be high due to, for example, the detection location 608A and the detection location 608D corresponding to a time instance at which both the Tx signal 602 and the Rx signal 604 have encoded a ‘1’.

At a detection location 608B, interference (and thus the optical intensity) in the summation signal is low (e.g., at a minimum) and, as such, the optical intensity at the detection location 608B is also low. The interference at the detection location 608B may be low due to, for example, the detection location 608B corresponding to a time instance at which both the Tx signal 602 and the Rx signal 604 have encoded a ‘0’.

At a detection location 608C, interference (and thus the optical intensity) in the summation signal is medium (e.g., an intermediate value between the maximum and the minimum) and, as such, the optical intensity at the detection location 608C is also medium. The interference at the detection location 608C may be medium due to, for example, the detection location 608C corresponding to a time instance at which one of the Tx signal 602 and the Rx signal 604 have encoded a ‘1’ and the other of the Tx signal 602 and the Rx signal 604 have encoded a ‘0’.

### Example Optical Interconnect

In some examples, an interconnect may achieve relatively high signaling speeds using multiple, parallel optical links. For example, an interconnect may achieve relatively high speed signalling (e.g., about 200 gigabits per second (Gbps) pulse amplitude modulation 4-level (PAM4) signalling) on a single transmit fiber and a separate and parallel receive fiber. That is, an interconnect may use electrical signaling to send and receive 200 Gbps on the same electrical differential pair. In some examples, however, achieving relatively high signaling speeds (e.g., signaling speeds of about 200 Gbps) in the optical domain may be challenging due to, for example, optical wavelength interference between a transmit and receive signal on the same physical optical medium. That is, while bi-directionality may be relatively easy to achieve with electrical interconnects, bi-directionality may be relatively difficult to achieve with optical interconnects. Furthermore, an optical modulator that encodes/sends data may not itself operate as the receiver/detector, thereby necessitating that optical communication occur in a simplex regime, in which the transmit and receive signals are separated, for example, in the spatial domain (e.g., sent using separate optical links), in the frequency domain (e.g., sent using separate carrier frequencies), or in the time domain (e.g., sent over separate time durations).

Various aspects of the present disclosure provide a method, optical interconnect, and device that enables optical bi-directionality in a single optical link (e.g., guide fiber) using common carrier frequency. By using the same physical connection (e.g., optical link) to send and receive information, an interconnect may increase (e.g., double) the infrastructure bandwidth capacity of the interconnect. In accordance with various aspects of the present disclosure, the self-heterodyne effect of optical signals is leveraged to achieve bi-directionality in optical interconnects. In other words, the self-heterodyne effect of optical signals is leveraged to enable de-embedding of two counter-propagating waves to enable simultaneous and bi-directional optical signaling on the same physical optical channel (e.g. sample physical connection) and optical devices.

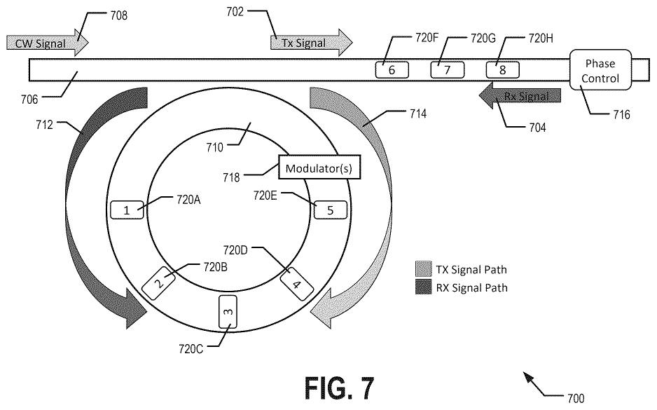

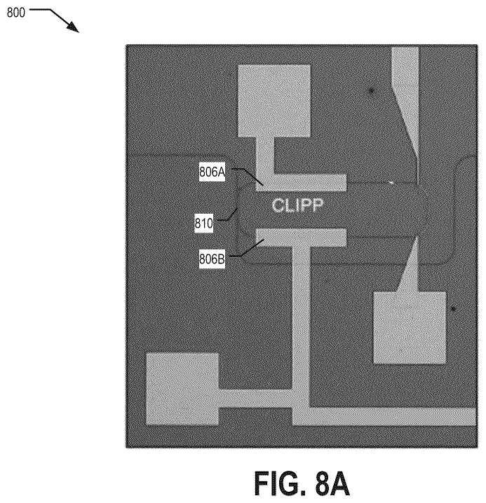

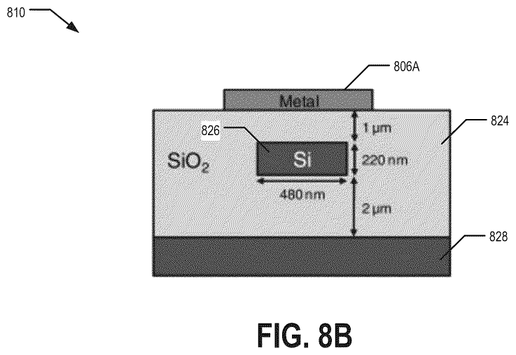

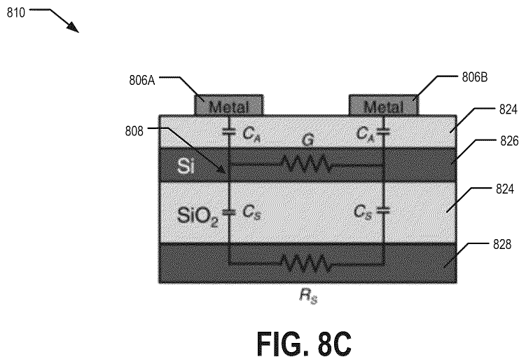

FIG. 7 illustrates a block diagram of an exemplary optical interconnect 700 in accordance with various embodiments. As illustrated in the example of FIG. 7, the optical interconnect 700 may include an optical link 706 and/or a micro-ring cavity 710. Optical link 706 and micro-ring cavity 710 may each be embodied as waveguides (Si cores enclosed by SiO₂ cladding). Optical link 706 and micro-ring cavity 710 may be separated by a small amount of SiO₂, and they may be planar with one another (within a single layer of SiO₂), as reflected in FIG. 8B-8C. Optical link 706 and micro-ring cavity 710 may be fabricated on a substrate (e.g., a silicon substrate). Optical link 706 may have a linear shape. Micro-ring cavity 710 may have a circular shape, an oval shape, or another shape suitable for ring resonators. Micro-ring cavity 710 may have a bending radius. In some examples, a standing wave pattern formed in micro-ring cavity 710 may be based on the bending radius.

In some examples, such as examples in which the optical interconnect 700 includes the optical link 706 and the micro-ring cavity 710, the micro-ring cavity 710 may be evanescently coupled to the optical link 706. For example, a non-modulated incoming optical signal (denoted as continuous wave (CW) signal 708) may be provided to the optical link 706 (e.g., optical guide). The CW signal 708 may determine (e.g., set the basis for) the wavelength and the phase of operation for at least a Tx signal 702. In some examples, CW signal 708 may determine the wavelength and the phase of operation for the Tx signal 702 and an Rx signal 704. The CW signal may be generated by a CW laser (e.g., 1.3 microns CW laser) with arbitrary phase. As the CW signal 708 propagates rightward on the optical link 706, the CW signal 708 evanescently couples to the micro-ring cavity 710, where the CW signal 708 propagates (e.g., travels) clockwise along a Tx signal path 714 and is modulated by one or more modulators 718 to form the Tx signal 702, on which transmit data is embedded. That is, the CW signal 708 may evanescently couple to the micro-ring cavity 710, where the CW signal 708 travels clockwise and is modulated by the one or more modulators 718, thereby forming a modulated Tx signal with a carrier frequency (set by the CW signal 708) and embedded binary data. In some examples, the one or more modulators 718 include one or more embedded, electro-optical modulators. In some examples, the one or more modulators 718 may serve as both modulators and detectors. As the modulated Tx signal 702 exits the micro-ring cavity 710 on to the optical link 706, the Tx signal 702 propagates to the right along the Tx signal path 714 (e.g., towards a receiver).

In some such examples, the Rx signal 704, which is modulated and embedded with receive data, may also be provided to the optical link 706. The incoming Rx signal 704 may be of substantially the same carrier frequency as the Tx signal 702 but of an undetermined phase. As the Rx signal 704 propagates leftward on the optical link 706, the Rx signal 704 evanescently couples to the micro-ring cavity 710, where the Rx signal 704 propagates counter-clockwise along an Rx signal path 712. The micro-ring cavity 710 may be an example of an on-resonance cavity. Thus, to evanescently couple to the micro-ring cavity 710, the Tx signal 702 and the Rx signal 704 are (e.g., must be) on-resonance to the micro-ring cavity 710 and, as such, of the same phase. That is, with both the Tx signal 702 and the Rx signal 704 being on-resonance to the micro-ring cavity 710 (which enables the Tx signal 702 and the Rx signal 704 to couple to the micro-ring cavity 710), the Tx signal 702 and the Rx signal 704 are in-phase with each other. With the Tx signal 702 and the Rx signal 704 being in-phase with each other within the micro-ring cavity, the Tx signal 702 and the Rx signal 704 may interfere and form a standing wave. That is, the interference pattern of the Tx signal 702 and the Rx signal 704 inside the micro-ring cavity 710 forms a standing wave. The term “standing wave,” as used herein, refers to a wave in which the crests/valleys are in stationary positions. In some examples, such as examples in which the standing wave is formed inside the micro-ring cavity 710, the positions of the crests/valleys (referred to as interference points) may be along the circumference of the micro-ring cavity 710. In some such examples, the positions of the interference points of the standing wave may be tuned to coincide with one or more position (e.g., a position of a sensor) on the micro-ring cavity 710 and/or the optical link 706. In some examples, the positions of the interference points may be based on the wavelength of operation (e.g., the wavelength of the CW signal 708, which may be about 1.3 microns).

The optical interconnect 700 may include a phase control component 716, which may be used to tune the phase of the Rx signal 704 (and/or Tx signal 702). In some examples, such as examples in which the optical interconnect 700 includes the optical link 706 (e.g., and lacks the micro-ring cavity 710) the optical interconnect 700 may use a phase control component 716 to synchronize the phase of the Rx signal 704 to the phase of the Tx signal 702. In other words, the phase control component 716 may be used to phase-match the Rx signal 704 to the Tx signal 702 and/or tune the positions of the interference points of the standing wave to coincide with one or more positions along the micro-ring cavity 710.

As illustrated in the example of FIG. 7, the optical link 706 and/or the micro-ring cavity 710 may be configured with one or more detection locations, which may correspond to one or more interference points. For example, the optical interconnect may include a non-destructive optical sensor positioned for detection (e.g., non-destructive heterodyne detection) of the optical power of the standing wave within one or more detection locations along the optical link 706 and/or the micro-ring cavity 710. For example, the non-destructive optical sensor may be positioned at locations along the optical link 706 and/or the micro-ring cavity 710 that coincide with the interference points of the standing wave.

In some examples, the non-destructive optical sensor may include one or more metal pads (e.g., a metal pad 720A, 720B, 720C, 720D, 720E, 720F, 720G, and/or 720H) positioned at the one or more detection locations. By tuning the standing wave to coincide with one or more of the metal pads 720, a non-destructive detection mechanism (e.g., a CLIPP or CLIPP-like detection mechanism) may be used to decode (and de-embed) the Tx signal 702 and the Rx signal 704. That is, metal pads may be integrated along the length of the optical link 706 (e.g., as shown by metal pads 6-8) and/or the micro-ring cavity 710 (e.g., as shown by metal pads 1-5) to decode a signal generated within the optical link 706 and/or the micro-ring cavity 710 by interference of the Tx signal 702 and the Rx signal 704. In some examples, such as examples in which the optical interconnect 700 includes metal pad 720F, metal pad 720G, and/or metal pad 720H (e.g., metal pad 6, 7, and/or 8), the optical interconnect 700 may use the phase control component 716 to achieve phase alignment between the Tx signal 702 and the Rx signal 704. The term “CLIPP-like,” as used herein, refers to a mechanism, device, or sensor configured for non-destructive optical detection.

In some other examples, such as examples in which the optical interconnect 700 includes metal pad 720A, metal pad 720B, metal pad 720C, metal pad 720D, and/or metal pad 720E (e.g., metal pad 1, 2, 3, 4, and/or 5), the micro-ring cavity 710 provides phase control. That is, the Tx signal 702 and the Rx signal 704 will automatically be in phase in the micro-ring cavity 710. In some examples, metal pads may be integrated along the length of the optical link 706 and the micro-ring cavity 710 to increase the accuracy of data stream decoding. In some examples, such as examples in which the optical interconnect 700 includes multiple metal pads, a spacing between two adjacent metal pads may be based on the wavelength of the CW signal 708 (e.g., the carrier frequency). For example, the wavelength of the CW signal 708 may be about 1.3 microns. In such an example, the metal pads 720 may have a width of about 0.5 microns and may have a spacing (e.g., if multiple metal pads are used) of about 1.3 microns.

In some examples, one or more metal pads may be positioned on the optical link 706. In some such examples, the phase control component 716 may be used to adjust (e.g., optimize) interference positions of the standing wave to the location(s) of the metal pad(s). In some examples, to reduce power consumption associated with phase control, a metal pad may be located relatively close to the phase control component 716.

Additionally, or alternatively, one or more metal pads may be positioned on the micro-ring cavity 710. In some such examples, the interference positions within the micro-ring cavity 710 may be based on the radius of the micro-ring cavity 710 and the wavelength of the CW signal 708. Accordingly, for a fixed micro-ring radius and wavelength, the interference positions within the micro-ring cavity 710 may also be fixed. As such, the one or more metal pads may be positioned at location(s) corresponding to the interference positions (e.g., crests).

In some examples, the non-destructive optical sensor may be an example of a non-invasive capacitive device that configured to detect carrier generation to a relatively high presence of optical fields. Such devices allow for the non-destructive, spatially dependent detection of optical signals.

FIG. 8A illustrates a top view of at least a portion of a non-invasive capacitive device 800 configured to detect carrier generation within a waveguide structure 810, in accordance with various embodiments. As illustrated in the example of FIG. 8A, the non-invasive capacitive device 800 may be an example of a CLIPP sensor (or a CLIPP-like sensor). In some examples, the non-invasive capacitive device 800 may include a metal pad 806A and a metal pad 806B (e.g., electrodes, such as CLIPP electrodes). As illustrated in the examples of FIGS. 8A, 8B, and 8C, the metal pads 806 may be integrated with the waveguide structure 810.

FIG. 8B illustrates a cross-section of the waveguide structure 810 and at least a portion of the non-invasive capacitive device (e.g., the metal pad 806A), in accordance with various embodiments. FIG. 8C illustrates a longitudinal profile of the waveguide structure 810 and at least a portion of the non-invasive capacitive device (e.g., the metal pad 806A and the metal pad 806B), in accordance with various embodiments. FIG. 8C also illustrates an equivalent circuit 808 of the waveguide structure 810 in the electrical domain.

The metal pads 806 may be examples of metal pads illustrated by and described with reference to FIG. 7. That is, the metal pads 806 may be examples of the metal pads 720. For example, the metal pads 806 may be positioned at detection locations on the waveguide structure 810 for detection of optical intensity of a standing wave generated by interference at the detection location of two optical signals counter-propagating on the waveguide structure 810. In some examples, the metal pads 806 may be positioned at the detection locations by placement of the metal pads 806 adjacent to the waveguide structure 810. As illustrated in the example of FIGS. 8B and 8C, such positioning of the metal pads 806 may include positioning the metal pads 806 on a silicon oxide (SiO₂) cladding 824 (e.g., an SiO₂ cladding layer) that abuts an Si core 826. The detection location is within the Si core 826, directly below the positioned metal pad 806. In some examples, metal pads 806 may be made of gold, platinum, or aluminum.

As illustrated in the examples of FIGS. 8B and 8C, the waveguide structure 810 may include the Si core 826 and the SiO₂ cladding 824. In the example of FIG. 8B, the Si core 826 has a width of about 480 nm and a height of about 220 nm. Additionally, in the example of FIG. 8B, the Si core 826 is positioned about 1 micron (μm) from a top surface of the waveguide structure 810 (on which the CLIPP electrodes are deposited) and about 2 μm from a top surface of a substrate 828 (on which the waveguide structure 810 is deposited). As illustrated in the example of FIG. 8A, the waveguide structure 810 may be an example of a micro-ring. That is, the waveguide structure 810 (e.g., a channel waveguide with the Si core 826) may form a micro-ring. As illustrated in the example of FIG. 8C, the metal pads 806 may monitor variations of the waveguide electric conductance (ΔG) with optical power (P) induced by a carrier generation effect, occurring at the native Si/SiO2 interface due to absorptive processes (e.g., due to two-photon absorption). That is, the metal pads 806 may detect changes in the optical intensity of a standing wave generated by interference of two optical signals counter-propagating on the Si core 826. The non-invasive capacitive device 800 may include one or more other components configured to support the monitoring of variations of ΔG with P induced by the carrier generation effect. For example, the non-invasive capacitive device 800 may include circuitry configured to read the electrical signal from the metal pads 806 and/or perform one or more control operations of the non-invasive capacitive device 800.

### Example Method for Determining Data Encoded on Optical Signals

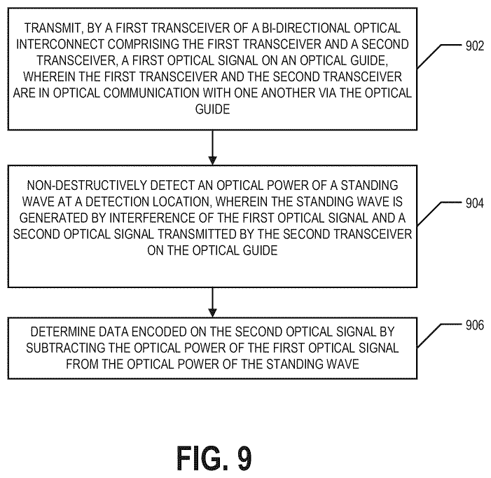

FIG. 9 illustrates a flowchart of a method for determining data encoded on optical signals counter propagating through an optical guide, in accordance with various embodiments. Starting at step 902, the method includes transmitting, by a first transceiver of a bi-directional optical interconnect including the first transceiver and a second transceiver, a first optical signal on an optical guide. The optical guide may be an example of an optical link described herein. For example, the optical guide may be an example of a waveguide or fiber. Additionally, the first transceiver and the second transceiver may be examples of transceivers described herein. For example, the first transceiver and the second transceiver may be in optical communication with one another via the optical guide.

At step 904, the method includes non-destructively detecting an optical power of a standing wave at a detection location. For example, the non-destructive optical sensor may be positioned for detection of the optical power of the standing wave within the detection location. In some examples, the standing wave is generated by interference of the first optical signal and a second optical signal transmitted by the second transceiver on the optical guide.

The detection location may be for detection of the optical power (or optical intensity) of the standing wave on the optical guide or a micro-ring. For example, the first transceiver may include a micro-ring (e.g., a micro-ring cavity) evanescently coupled to the optical guide. In some examples, due to the micro-ring being evanescently coupled to the optical guide, at least a portion of the first optical signal and at least a portion of the second optical signal transfer (e.g., tunnel) from the optical guide to the micro-ring. For example, the first transceiver may be configured to generate a non-modulated optical signal and the micro-ring may include at least one modulator configured to generate the first optical signal through modulation of the non-modulated optical signal. In such an example, as the non-modulated optical signal propagates in a first direction on the optical guide, the non-modulated optical signal evanescently couples to the micro-ring (and is modulated to form the first optical signal). Additionally, as the second optical signal propagates in a second (opposite) direction on the optical guide, the second optical signal also evanescently couples to the micro-ring. In such an example, generation of the standing wave may be based on the portion of the first optical signal and the portion of the second optical signal counter propagating through the micro-ring. For example, the first optical signal and the second optical signal may have substantially the same wavelength and the standing wave may result from interference between the portion of the first optical signal and the portion of the second optical signal within the micro-ring.

In some examples, the detection location is for detection of the optical power (or optical intensity) of the standing wave on the optical guide. In some such examples, the second transceiver includes a phase control component configured to synchronize a phase of the second optical signal to a phase of the first optical signal. In some examples, the non-destructive optical sensor (e.g., multiple pads) may be configured to detect the optical intensity of the standing wave at multiple detection locations. In some such examples, the multiple detection locations may be for detection of the optical power of the standing wave on the optical guide and/or the micro-ring.

At step 906, the method includes determining data encoded on the second optical signal by subtracting the optical power of the first optical signal from the optical power of the standing wave. For example, the standing wave may be an example of a self-heterodyned signal, which may be compared to the first optical signal (e.g., via a calibrated truth table) to the de-embed the first optical signal and the second optical signal from the self-heterodyned signal. By de-embedding the first optical signal and the second optical signal from the self-heterodyned signal, the data encoded on the second optical signal may be determined.

### Example System Use Cases

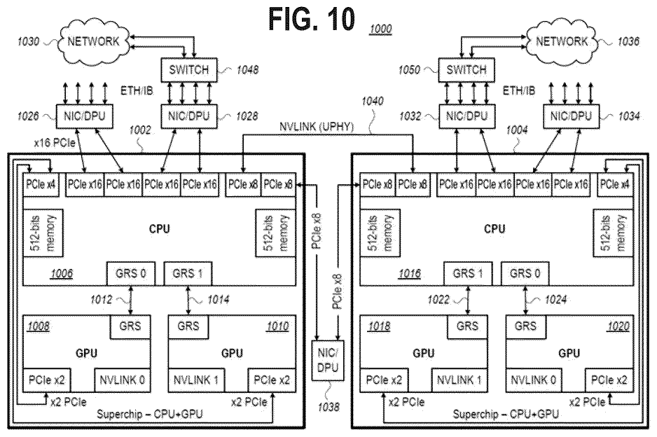

FIG. 10 illustrates a block diagram that schematically illustrates a computing system 1000, e.g., a data center or a High-Performance Computing (HPC) cluster, in accordance with an embodiment that is described herein. System 1000 includes multiple subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 includes a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 10 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 10, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 10, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects. The packet switches in FIG. 10 may include, for example, Nvidia Quantum-2 switches. The NICs/DPUs in the figure may include, for example, Nvidia Bluefield DPUs.

In various embodiments, one or more of the interconnects 1012, 1014, 1022, 1024 may be optical interconnects disclosed herein. Additionally, in various embodiments, switches 1048, 1050 may be in communication with NIC/DPU 1028, 1032, respectively, via one or more optical interconnects disclosed herein. In some embodiments, NIC/DPU 1026, 1034 may be in communication with one or more additional elements via optical interconnects disclosed herein. For example, various elements of the computing system 1000 may be in communication with one another via one or more optical interconnects disclosed herein.

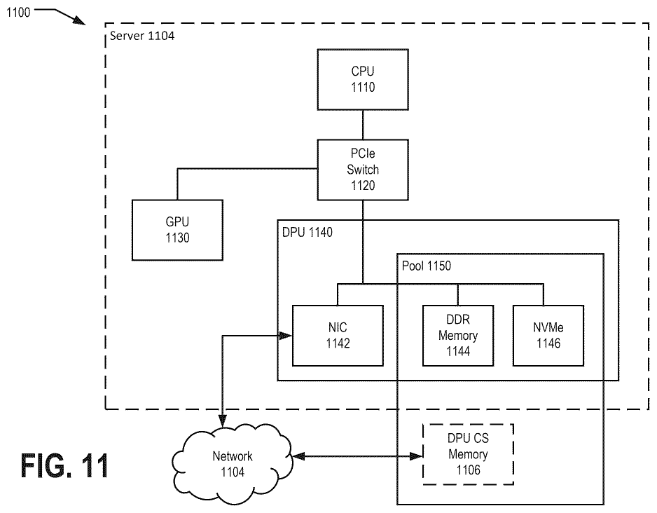

FIG. 11 illustrates an example computing environment 1100 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 1100 may include a server 1102 which may be used to perform high performance computing (HPC) workloads, such as AI training or machine learning model training. In an embodiment, the server 1102 may be an application instance or a compute node. The server 1102 may include a CPU 1110 associated with a switch 1120, such as a peripheral component interconnect express (PCIe) switch, which may control at least some data transmission over communication paths interconnecting various components. In an embodiment, the CPU 1110 may include a root complex processor.

The PCIe switch 1120 may also be associated with a GPU 1130 and a DPU 1140, and may transmit data between at least some of the CPU 1110, the GPU 1130, the DPU 1140, and other components (e.g., via one or more optical interconnects disclosed herein). In an embodiment, the PCIe switch 1120 may be associated with more than one GPU or more than one DPU. In another embodiment, the PCIe switch 1120 may be located within the DPU 1140. The PCIe switch 1120 may manage the transfer of at least some data between the CPU 1110, the GPU 1130, and the DPU 1140. In another embodiment, the number of GPUs associated with the PCIe switch 1120 may be equal to the number of DPUs associated with the PCIe switch 1120. In at least one embodiment, the server 1102 may include, without limitation, any number of the CPUs 1110, the PCIe switches 1120, the GPUs 1130, and/or the DPUs 1140, in any combination. For example, in at least one embodiment, server 1102 could include eight, sixteen, thirty-two, and/or more GPUs 1130. In at least one embodiment, communication paths interconnecting various components, including but not limited to the CPU 1110, the PCIe switch 1120, the GPU 1130, and the DPU 1140, in FIG. 11 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 1140 may include a network interface controller (NIC) 1142, a double data rate (DDR) memory 1144, and a non-volatile memory express (NVMe) device 1146. The NIC 1142 may be able to interface with a network 1104, which may also interface with additional NVMe devices available to the DPU 1140, such as over fabric. In an embodiment, the DPU 1140 may not include the NVMe device 1146. In another embodiment, the NVMe device 1146 may be located on the server 1102 and not on the DPU 1140. In yet another embodiment, the computing environment 1100 may include more than one of the NVMe device 1146, such as a first NVMe device in the DPU 1140 and a second first NVMe device on the server 1102 an associated directly with the PCIe switch 1120. In an embodiment, the DPU 1140 may not include the DDR memory 1144 and may include a computational storage services (CSS) in place of, or in addition to, the DDR memory 1144. For example, computing environment 1100 may include DPU computational storage (CS) memory 1106 available to the DPU 1140 as part of the CSS. The network 1104 may be able to interface with the DPU CS memory 1106 through the NIC 1142, according to any suitable interface protocol, such as remote direct memory access (RDMA) over Ethernet, InfiniBand, Fiber Channel, etc.

The total memory of the computing environment 1100 available for data storage may be expanded through the use of the DPU 1140 on nodes of the system. The DPU 1140 may have access to a pool 1150 of memory already available to the server 1102, such as DDR memory, on-board NVMe devices, NVMe devices over fabric, and CS. The pool 1150 of memory may include at least one of the DDR memory 1144, NVMe device 1146, and the DPU CS memory 1106. The DPU 1140 may also be able to access the available memory of other DPUs as part of the pool 1150, and other DPUs may be able to access the available memory of DPU 1140, such as the pool 1150. This available memory can be accessed and utilized for data storage, without the addition of compute resources, such as compute nodes, which would be required using other solutions. The available pool 1150 accessible to the DPU 1140 may be provisioned for the server 1102 to expand the total memory available for data storage, such as to reduce the data storage load on the CPU 1110 or the GPU 1130, which can instead increase the utilization of their memory for processing. For example, during training of an AI, the model states, residual states, activation functions, and checkpoints can be stored, or offloaded, on the pool 1150 accessible to the DPU 1140.

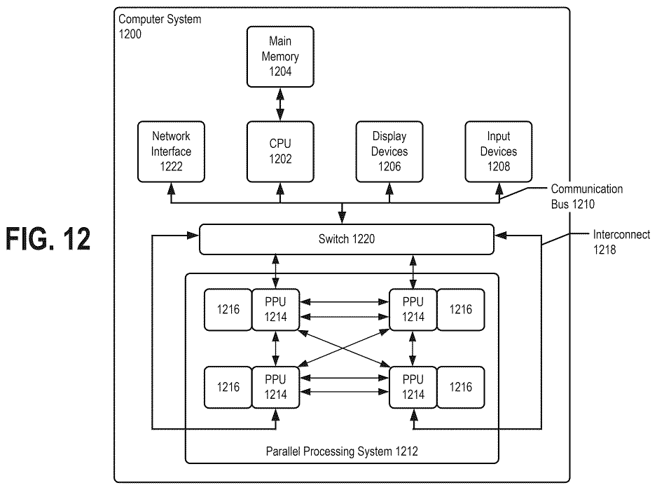

FIG. 12 illustrates an example computer system 1200 that may include optical interconnects, in accordance with various embodiments. In at least one embodiment, computer system 1200 includes at least one optical interconnect of an example embodiment.

In at least one embodiment, computer system 1200 includes, without limitation, at least one central processing unit (“CPU”) 1202 that is connected to a communication bus 1210 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 1200 includes, without limitation, a main memory 1204 and control logic (e.g., implemented as hardware, software, or a combination thereof) and data are stored in main memory 1204 which may take form of random access memory (“RAM”). In at least one embodiment, a network interface subsystem (“network interface”) 1222 provides an interface to other computing devices and networks for receiving data from and transmitting data to other systems from computer system 1200.

In at least one embodiment, computer system 1200, in at least one embodiment, includes, without limitation, input devices 1208, parallel processing system 1212, and display devices 1206 which can be implemented using a conventional cathode ray tube (“CRT”), liquid crystal display (“LCD”), light emitting diode (“LED”), plasma display, or other suitable display technologies. In at least one embodiment, user input is received from input devices 1208 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 1204 and/or secondary storage. Computer programs, if executed by one or more processors, enable system 1200 to perform various functions in accordance with at least one embodiment. memory 1204, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 1202; parallel processing system 1212; an integrated circuit capable of at least a portion of capabilities of both CPU 1202; parallel processing system 1212; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 1200 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 1212 includes, without limitation, multiple parallel processing units (“PPUs”) 1214 and associated memories 1216. In at least one embodiment, PPUs 1214 are connected to a host processor or other peripheral devices via an interconnect 1218 and a switch 1220 or multiplexer. In at least one embodiment, parallel processing system 1212 distributes computational tasks across PPUs 1214 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 1214, although such shared memory may incur performance penalties relative to use of local memory and registers resident to a PPU 1214. In at least one embodiment, operation of PPUs 1214 is synchronized through use of a command such as_syncthreads( ), wherein all threads in a block (e.g., executed across multiple PPUs 1214) to reach a certain point of execution of code before proceeding.

The PPUs 1214 may be in communication with one another and/or switch 1220 via one or more optical interconnects in accordance with example embodiments disclosed herein.

### Example Datacenter

In various embodiments, a system including an optical interconnect 100 and/or an optical network 200 may be part of a datacenter. For example, the system may be used to place various components of a datacenter in communication with one another. Datacenters may include multiple network switches in a particular topology, such as a fat tree topology, a slim fly topology, a dragonfly topology, and/or the like. The specifications and makeup of the network switches in the topology affects the overall network performance (e.g., bandwidth capability) of the datacenter.

Datacenters are the storage and data processing hubs of the internet. The massive deployment of cloud applications is causing datacenters to expand exponentially in size, stimulating the development of faster switches than can cope with the increasing data traffic inside the datacenter. Current state-of-the-art switches are capable of handling 12.8 Tb/s of traffic by employing electrical switches in the form of application specific integrated circuits (ASICs) equipped with data lanes, each operating at 50 Gb/s. Such switching ASICs typically consume as much as 400 W, and the power consumption of the optical transceiver interfaces attached to each ASIC is comparable. To keep pace with traffic demand, switch capacity doubles approximately every two years. To date, this rapid scaling has been made possible by exploiting advances in manufacturing (e.g., complementary metal oxide semiconductor (CMOS) techniques), collectively described by Moore's law (i.e., the observation that the number of transistors in a dense integrated circuit doubles about every two years). However, in recent years there are strong indications of Moore's law slowing down, which raises concerns about the capability to sustain the target scaling rate of switch capacity. As a result, alternative technologies are being investigated.

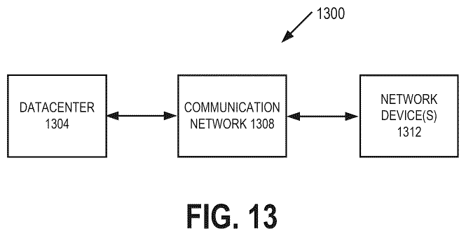

FIG. 13 illustrates a system 1300, in accordance with various embodiments. The system 1300 includes a datacenter 1304, a communication network 1308, and one or more network devices 1312. In at least one example embodiment, the datacenter 1304 corresponds to a collection of network devices, such as network switches (e.g., Ethernet switches) connected with a collection of servers or compute nodes. The datacenter 1304 may adhere to a networking topology (e.g., a hierarchal networking topology), such as a fat tree topology, a Slim Fly topology, a Dragonfly topology, and/or the like. The datacenter 1304 routes traffic amongst the network switches and servers therein, and at least one layer of the topology in the datacenter 1304 is coupled to the communication network 1308 to allow networking traffic to flow between the datacenter 1304 and the network device(s) 1312.

Examples of the communication network 1308 that may be used to connect the datacenter 1304 and the network device(s) 1312 include an Internet Protocol (IP) network, an Ethernet network, an InfiniBand (TB) network, a Fibre Channel network, the Internet, a cellular communication network, a wireless communication network, combinations thereof (e.g., Fibre Channel over Ethernet), variants thereof, and/or the like.

The one or more network devices 1312 may include switch, router, or Network Interface Controller (NIC), interconnect using ports, one or more of Personal Computer (PC), a laptop, a tablet, a smartphone, a server, a collection of servers, and/or any suitable computing device for sending and receiving signals over the communication network 1308. In at least one example embodiment, the one or more network devices 1312 correspond to another datacenter, similar to or the same as datacenter 1304.

As noted above, the datacenter 1304 and/or the network device(s) 1312 may include storage devices and/or processing circuitry for carrying out computing tasks, for example, tasks associated with controlling the flow of data internally and/or over the communication network 1308. Such processing circuitry may include software, hardware, or a combination thereof. For example, the processing circuitry may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory).

Additionally, or alternatively, the processing circuitry may include hardware, such as an ASIC. For example, the processor may be or include one or more of an Integrated Circuit (IC) chip, a microprocessor, a CPU, a GPU, a DPU, a Field Programmable Gate Array (FPGA), a network interface controller (NIC), an ASIC, combinations thereof, and the like. The processing circuitry may include an ASIC and/or may be capable of performing as a CPU, a GPU, a network interface controller (NIC), a DPU, or any other computing device in which with data is received and/or transmitted.

Some or all of the processing circuitry may be provided on a Printed Circuit Board (PCB) or collection of PCBs. It should be appreciated that any appropriate type of electrical component or collection of electrical components may be suitable for inclusion in the processing circuitry.

In addition, although not explicitly shown, it should be appreciated that the datacenter 1304 and network device(s) 1312 may include one or more communication interfaces for facilitating wired and/or wireless communication between one another and other unillustrated elements of the system 1300.

In related art systems, a fat tree topology may use the same electrical switching devices on all layers (edge, aggregation, core). For example, each switching device may be 1 U switch, where 1 U refers to the industry standard size for rack-mounted switch and/or server. The interconnection between switches of different layers may be accomplished with optical links using active optical cables and optical transceivers implemented in a pluggable form factor (also referred to as “pluggables”).

Optical Datacenter Networks rely on allocation and deallocation of light paths from the data sources to the destinations end-ports to guarantee no light collisions and data loss occur in the fabric. Traditionally the allocation algorithms are run from a central entity which considers the entire demand for source and destination flows and try to find the most dense mapping of these demands to network resources over a single or multiple time periods.

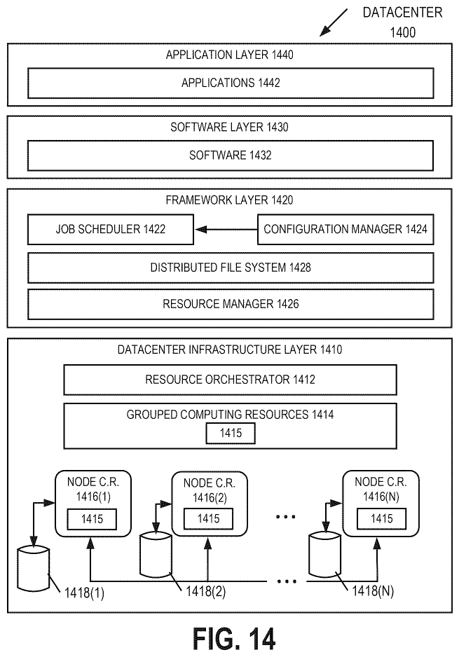

FIG. 14 illustrates a schematic diagram of an example datacenter 1400 that may include one or more optical chips in accordance with various embodiments. In at least one embodiment, datacenter 1400 includes a datacenter infrastructure layer 1410, a framework layer 1420, a software layer 1430, and an application layer 1440.

In at least one embodiment, as shown in FIG. 14, datacenter infrastructure layer 1410 may include a resource orchestrator 1412, grouped computing resources 1414, and node computing resources (“node C.R.s”) 1416(1)-1416(N), where “N” represents a positive integer (which may be a different integer “N” than used in other figures). In at least one embodiment, node C.R.s 1416(1)-1416(N) may include, but are not limited to, any number of central processing units (“CPUs”) or other processors (including accelerators, field programmable gate arrays (FPGAs), graphics processors, etc.), memory storage devices 1418(1)-1418(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 1416(1)-1416(N) may be a server having one or more of above-mentioned computing resources.

In at least one embodiment, grouped computing resources 1414 may include separate groupings of node C.R.s housed within one or more racks (not shown), or many racks housed in datacenters at various geographical locations (also not shown). In at least one embodiment, separate groupings of node C.R.s within grouped computing resources 1414 may include grouped compute, network, memory, or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1412 may configure or otherwise control one or more node C.R.s 1416(1)-1416(N) and/or grouped computing resources 1414. In at least one embodiment, resource orchestrator 1412 may include a software design infrastructure (“SDI”) management entity for datacenter 1400. In at least one embodiment, resource orchestrator 1412 may include hardware, software or some combination thereof.

In at least one embodiment, as shown in FIG. 14, framework layer 1420 includes a job scheduler 1422, a configuration manager 1424, a resource manager 1426 and a distributed file system 1428. In at least one embodiment, framework layer 1420 may include a framework to support software 1432 of software layer 1430 and/or one or more application(s) 1442 of application layer 1440. In at least one embodiment, software 1432 or application(s) 1442 may respectively include web-based service software or applications, such as those provided by Amazon Web Services, Google Cloud and Microsoft Azure. In at least one embodiment, framework layer 1420 may be, but is not limited to, a type of free and open-source software web application framework such as Apache Spark™ (hereinafter “Spark”) that may utilize distributed file system 1428 for large-scale data processing (e.g., “big data”). In at least one embodiment, job scheduler 1422 may include a Spark driver to facilitate scheduling of workloads supported by various layers of datacenter 1400. In at least one embodiment, configuration manager 1424 may be capable of configuring different layers such as software layer 1430 and framework layer 1420 including Spark and distributed file system 1428 for supporting large-scale data processing. In at least one embodiment, resource manager 1426 may be capable of managing clustered or grouped computing resources mapped to or allocated for support of distributed file system 1428 and job scheduler 1422. In at least one embodiment, clustered or grouped computing resources may include grouped computing resources 1414 at datacenter infrastructure layer 1410. In at least one embodiment, resource manager 1426 may coordinate with resource orchestrator 1412 to manage these mapped or allocated computing resources.

In at least one embodiment, software 1432 included in software layer 1430 may include software used by at least portions of node C.R.s 1416(1)-1416(N), grouped computing resources 1414, and/or distributed file system 1428 of framework layer 1420. In at least one embodiment, one or more types of software may include, but are not limited to, Internet web page search software, e-mail virus scan software, database software, and streaming video content software.

In at least one embodiment, application(s) 1442 included in application layer 1440 may include one or more types of applications used by at least portions of node C.R.s 1416(1)-1416(N), grouped computing resources 1414, and/or distributed file system 1428 of framework layer 1420. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1424, resource manager 1426, and resource orchestrator 1412 may implement any number and type of self-modifying actions based on any amount and type of data acquired in any technically feasible fashion. In at least one embodiment, self-modifying actions may relieve a datacenter operator of datacenter 1400 from making possibly bad configuration decisions and possibly avoiding underutilized and/or poor performing portions of a datacenter.

In at least one embodiment, datacenter 1400 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 1400. In at least one embodiment, trained machine learning models corresponding to one or more neural networks may be used to infer or predict information using resources described above with respect to datacenter 1400 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 1415 are used to perform inferencing and/or training operations associated with one or more embodiments. In at least one embodiment, inference and/or training logic 1415 may be used in system FIG. 14 for inferencing or predicting operations based, at least in part, on weight parameters calculated using neural network training operations, neural network functions and/or architectures, or neural network use cases described herein.

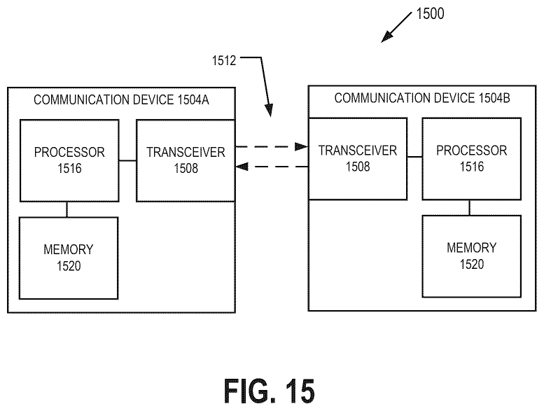

FIG. 15 illustrates a block diagram of example communication devices 1504 in communication with one another in accordance with various embodiments. For example, FIG. 15 illustrates a system 1500 including a first communication device 1504A and a second communication device 1504B. Illustratively, but without limitation, the communication devices 1504 (e.g., 1504A, 1504B) may correspond to network devices (e.g., network devices 1015). As such, the communication devices 1504 may correspond to any type of device that becomes part of or is connected with a communication network. Examples of suitable devices that may act or operate like one of the communication devices 1504 as described herein include, without limitation, one or more of a Personal Computer (PC), a laptop, a tablet, a smartphone, a server, a collection of servers, a networking card, an edge router, a switch, Network Interface Controller, a Top of Rack (ToR) switch, a server blade, or the like. The communication device 1504 may include a transceiver 1508, a processor 1516, and memory 1520. The transceiver 1508 may include hardware that enables communications over the communication channel 1512 whereas the processor 1516 and memory 1520 may include components that enable the communication device 1504 to provide a desired functionality or perform certain functions.

The communication channel 1512 may traverse a datacenter or any type of communication network (whether trusted or untrusted). Examples of a communication network that may be used to connect communication devices 1504 and support the communication channel 1512 include, without limitation, an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific, but non-limiting example, the communication network enables data transmission between the communication devices 1504 using optical signals. In this case, the communication devices 1504 and the communication network may include waveguides (e.g., optical fibers) that carry the optical signals. For example, the communication devices and/or the communication network may include one or more optical links 600, according to various embodiments.

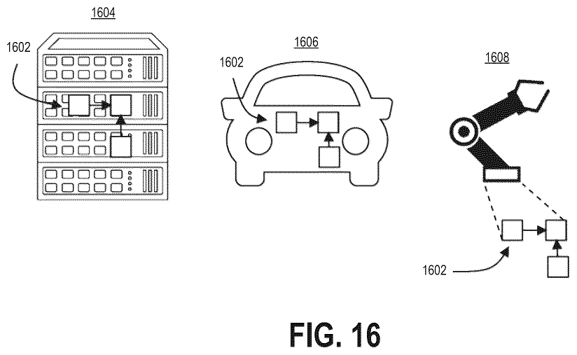

FIG. 16 illustrates exemplary scenarios for use of an optical transceiver 1602 in accordance with some embodiments. An optical transceiver 1602 may be utilized in a computing system 1604 (e.g., in a server farm, or within a server computer system), a vehicle 1606 (e.g., a car, truck, train, or airplane), and a robot 1608 (or among robots in a factory), to name just a few examples. The optical transceiver 1602 may be particularly useful for high-speed communication in environments subject to high levels of electromagnetic interference (EMI).

### Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An optical interconnect comprising:
a first transceiver and a second transceiver; and
an optical guide, wherein the first transceiver is in optical communication with the second transceiver via the optical guide,
wherein the first transceiver is configured to transmit a first optical signal via the optical guide and to receive a second optical signal via the optical guide, and
wherein the first transceiver comprises a non-destructive optical sensor configured to detect optical intensity of a standing wave generated by interference of the first optical signal and the second optical signal at a detection location.

2. The optical interconnect of claim 1, wherein the first transceiver comprises a micro-ring cavity evanescently coupled to the optical guide, wherein, based at least in part on the micro-ring cavity being evanescently coupled to the optical guide, at least a portion of the first optical signal and at least a portion of the second optical signal transfer from the optical guide to the micro-ring cavity, and wherein generation of the standing wave is based at least in part on the portion of the first optical signal and the portion of the second optical signal counter propagating through the micro-ring cavity.

3. The optical interconnect of claim 2, wherein the first transceiver is configured to generate a non-modulated optical signal, and wherein the micro-ring cavity comprises at least one modulator configured to generate the first optical signal through modulation of the non-modulated optical signal.

4. The optical interconnect of claim 3, wherein the first optical signal and the second optical signal have a common wavelength, and wherein the common wavelength is based at least in part on the non-modulated optical signal.

5. The optical interconnect of claim 2, wherein the detection location is for detection of the optical intensity of the standing wave on the optical guide or the micro-ring.

6. The optical interconnect of claim 5, wherein the detection location is for detection of the optical intensity of the standing wave on the optical guide, and wherein, based at least in part on the detection location, the second transceiver comprises a phase control component configured to synchronize a phase of the second optical signal to a phase of the first optical signal.

7. The optical interconnect of claim 2, wherein the non-destructive optical sensor is configured to detect the optical intensity of the standing wave at a plurality of detection locations including the detection location, and wherein the plurality of detection locations is for detection of the optical intensity of the standing wave on at least one of the optical guide or the micro-ring.

8. The optical interconnect of claim 1, wherein the non-destructive optical sensor is positioned for detection of the optical intensity of the standing wave within the detection location.

9. The optical interconnect of claim 1, wherein the non-destructive optical sensor comprises one or more metal pads.

10. A method comprising:
transmitting, by a first transceiver of a bi-directional optical interconnect comprising the first transceiver and a second transceiver, a first optical signal on an optical guide, wherein the first transceiver and the second transceiver are in optical communication with one another via the optical guide;
non-destructively detecting an optical power of a standing wave at a detection location, wherein the standing wave is generated by interference of the first optical signal and a second optical signal transmitted by the second transceiver on the optical guide; and
determining data encoded on the second optical signal by subtracting the optical power of the first optical signal from the optical power of the standing wave.

11. The method of claim 10, wherein the first transceiver comprises a micro-ring evanescently coupled to the optical guide, wherein, based at least in part on the micro-ring being evanescently coupled to the optical guide, at least a portion of the first optical signal and at least a portion of the second optical signal transfer from the optical guide to the micro-ring, and wherein generation of the standing wave is based at least in part on the portion of the first optical signal and the portion of the second optical signal counter propagating through the micro-ring.

12. The method of claim 11, wherein the first transceiver is configured to generate a non-modulated optical signal, and wherein the micro-ring comprises at least one modulator configured to generate the first optical signal through modulation of the non-modulated optical signal.

13. The method of claim 12, wherein the first optical signal and the second optical signal have a common wavelength, and wherein the common wavelength is based at least in part on the non-modulated optical signal.

14. The method of claim 11, wherein the detection location is for detection of the optical power of the standing wave on the optical guide or the micro-ring.

15. The method of claim 14, wherein the detection location is on the optical guide, and wherein, based at least in part on the detection location, the second transceiver comprises a phase control component configured to synchronize a phase of the second optical signal to a phase of the first optical signal.

16. The method of claim 11, wherein non-destructively detecting the optical power of the standing wave comprises:
non-destructively detecting the optical power of the standing wave at a plurality of detection locations including the detection location, wherein the plurality of detection locations is for detection of the optical power of the standing wave on at least one of the optical guide or the micro-ring.

17. The method of claim 10, wherein non-destructively detecting the optical power of the standing wave comprises:
non-destructively detecting the optical power of the standing wave via a non-destructive optical sensor positioned for detection of the optical power of the standing wave within the detection location.

18. The method of claim 17, wherein the non-destructive optical sensor comprises one or more metal pads.

19. A device comprising:
an optical interconnect structure comprising at least a transceiver and an optical guide, wherein the transceiver is configured for:
transmitting a first optical signal on the optical guide;
performing non-destructive heterodyne detection of the first optical signal and a second optical signal counter-propagating on the optical guide; and
determining data encoded on the second optical signal based at least in part on data encoded on the first optical signal.

20. The device of claim 19, wherein the transceiver comprises a micro-ring evanescently coupled to the optical guide, wherein, based at least in part on the micro-ring being evanescently coupled to the optical guide, at least a portion of the first optical signal and at least a portion of the second optical signal transfer from the optical guide to the micro-ring.
